(19) United States
(12) Patent Application Publication
(10) Pub. No.: US 2026/0261558 A1
(43) Pub. Date: Sep. 3, 2026

(54) CONTEXT-BASED ENTERPRISE ENVIRONMENT SECURITY USING DEEP LEARNING

(71) Applicant: DELL PRODUCTS L.P., Round Rock, TX (US)

(72) Inventors: Parminder Singh Sethi, Ludhiana (IN); Avinash Kumar, Patna (IN); Praveen Kumar, Noida (IN)

(21) Appl. No.: 19/067,955

(22) Filed: Mar. 2, 2025

(51) Int. Cl. H04L 9/40; H04L 41/16

(52) U.S. Cl. CPC H04L 63/102; H04L 41/16; H04L 63/20

(57) ABSTRACT

A system controlling, in real time, user access to resources of an enterprise information technology (IT) infrastructure includes an activity detector configured to collect contextual data from data sources in response to a user attempting to access a resource of the enterprise IT infrastructure. A feature extraction engine coupled with the activity detector is configured to extract features from the contextual data collected by the activity detector. A behavior classifier coupled with the feature extraction engine is configured to implement a machine learning model that is trained to generate a role prediction by classifying behavior of the user based on input of the features. An access controller coupled with the behavior classifier is configured to assign a role priority to the user based on the prediction generated by the machine learning model, the role priority determining which resources of the enterprise IT infrastructure that the user is able to access.

### FIELD OF THE DISCLOSURE

The present disclosure generally relates to information handling systems, and more particularly relates to protecting data and systems within an enterprise environment.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A system for controlling, in real time, user access to resources of an enterprise information technology (IT) infrastructure includes an activity detector configured to collect contextual data from one or more data sources in response to a user attempting to access a resource of the enterprise IT infrastructure. A feature extraction engine coupled with the activity detector is configured to extract features from the contextual data collected by the activity detector. A behavior classifier coupled with the feature extraction engine is configured to implement a machine learning model that is trained to generate a role prediction by classifying behavior of the user based on input of the features extracted by the feature extraction engine. An access controller coupled with the behavior classifier is configured to assign a role priority to the user based on the prediction generated by the machine learning model, the role priority determining which resources of the enterprise IT infrastructure that the user is able to access.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an enterprise environment including multiple information handling systems and a context-based security prioritization (CBSP) framework for controlling access to resources of the enterprise environment, according to an embodiment of the present disclosure;

FIG. 2 is a block diagram of an exemplary architecture of the CBSP framework for controlling access to resources of the enterprise environment according to an embodiment of the present disclosure

FIG. 3 is a flow diagram of a method for controlling, in real time, user access to resources of an enterprise information technology (IT) infrastructure according to an embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

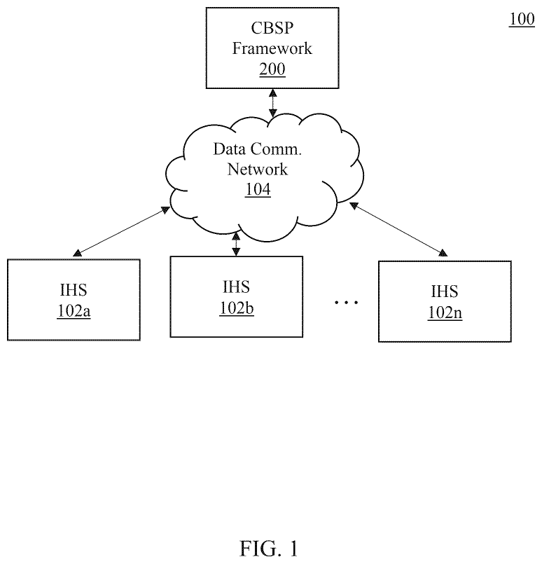

FIG. 1 is a block diagram of an enterprise environment 100 that includes multiple information handling systems 102a and 102b through 102n (where n is a positive integer) interconnected via a data communications network 104, such as a local area network (LAN) or a wide area network (WAN). For purposes of this disclosure, information handling systems 102a-102n can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), network storage device, or any other suitable device and may vary in size, shape, performance, functionality, and/or price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Businesses and other organizations increasingly rely on an information technology (IT) infrastructure made up of numerous, interconnected information handling systems for carrying out the organization's operations. The various types of information handling systems taken together provide an ecosystem such as enterprise environment 100 that supports an enterprise or organization's operations by automating, monitoring, and managing many different processes across the organization. Information handling systems 102a-102n along with the processes that run on them and the data stored, used, and generated by the processes are critical resources of every enterprise environment.

Referring still to FIG. 1, enterprise environment 100 also includes context-based security prioritization (CBSP) framework 200. CBSP framework 200 is configured to provide context-based role prioritization for protecting the resources of the information technology (IT) infrastructure that makes up enterprise environment 100. In certain embodiments, CBSP framework 200 is configured to provide a type of role-based access control (RBAC) that dynamically prioritizes user roles and manages the security context of resources of the IT infrastructure of enterprise environment 100. CBSP framework 200 is configured to dynamically assess and update users'role priorities. A role priority determines which resources of enterprise environment 100 a user (e.g., employee or guest) may access. Ensuring robust security of the resources without impeding operations of the enterprise through overly restrictive role prioritization is a complex task. This may be especially so given the diversity of roles within enterprise environment 100 and the likelihood that the roles along with security requirements change as the enterprise evolves over time.

CBSP framework 200 is configured to assess and update users'role priorities in real time using contextualized data. As used herein, “contextualized data” means data that is generated by, and which defines, a user's activities and the conditions of enterprise environment 100 under which the activities are undertaken by the user. For example, operating system data generated in response to a user's logging into an information handling system or attempting to access a database communicatively coupled with data communications network 104 is contextualized data indicating activity. Contextualized data includes a context such as the user's geographic location, access history, device type, and real-time network activity, for example. Contextualized data may include any data relevant for defining the context under which user activity is undertaken given that the activity has a potential to affect the security of the resources of enterprise environment 100.

In certain embodiments, CBSP framework 200 utilizes machine learning models trained to classify user behavior based on contextualized data and to dynamically adjust the role priority assigned to a user, in real time. A machine learning classifier model, in some embodiments, may be trained using supervised learning. Using labeled data as training examples, the machine learning model is trained to recognize patterns of user behavior such that through pattern recognition the model may classify user behavior. In some embodiments, the classification may be a binary one, with user behavior classified as normal or anomalous behavior. In other embodiments, CBSP framework 200 may implement reinforcement learning to fine tune CBSP framework 200's actions in assigning a role priority to a user. In certain embodiments the reinforcement learning is performed by a deep learning neural network that includes a reward-penalty function to reward or penalize decisions to permit or prevent a user's access to resources of enterprise environment 100. Through reinforcement learning, CBSP framework 200 learns which decisions made regarding assignment of role priorities are most likely to optimize the trade-off between maintaining the security of the resources of enterprises environment 100 and the need to promote user productivity by avoiding unnecessary restrictions on access to the resources.

CBSP framework 200 provides technical improvements over conventional identity and access management (IAM) systems and other RBAC systems. A conventional RBAC system typically grants or restricts user access to a resource or resource based on a mapping between a role assigned to the user and access rights corresponding to the user's designated role. The role designations and mappings are often static and only periodically updated. Updating is often performed manually and thus is susceptible to human error, which can lead to potential security gaps and/or productivity diminishment owing to a user with a legitimate reason of accessing a resource being denied access. Even when done correctly the updating itself is usually a burdensome task, especially for a large organization. The updating is typically not done in real time. Moreover, many conventional RBAC systems rely heavily on predetermined conditions and are thus unable to efficiently handle changing or unpredictable security scenarios. Conventional RBAC systems tend to be inflexible, typically failing to adapt to an evolution of roles that often occurs if the organization evolves or if new security threats emerge.

By contrast, CBSP framework 200 dynamically prioritizes user roles and adapts to changing conditions in real time, regardless of whether the changes relate to user roles and/or security of the resources of enterprise environment 100.

In the various embodiments described in this disclosure, CBSP framework 200 may be implemented as a complete system for controlling user access to the resources of enterprise environment 100 in real time. It will be readily appreciated by one skilled in the art, however, that in other embodiment CBSP framework 200 may be implemented to operate in conjunction with such a legacy IAM system or RBAC system, providing real-time override of role priorities as warranted given a specific context. For example, the context may be an emerging security threat not previously encountered. Contextual data relied on by CBSP framework 200 may include data on real-time activity of data communication network 104 (e.g., anomalies, bandwidth usage, active connections), which can reveal the security threat. Responding to the security threat in real time, CBSP framework 200 may override static RBAC role priorities and instigate updated, more restrictive role priorities for users until such time as the suddenly emerging threat has been adequately dealt with. CBSP framework 200 is capable of responding to the threat in real time.

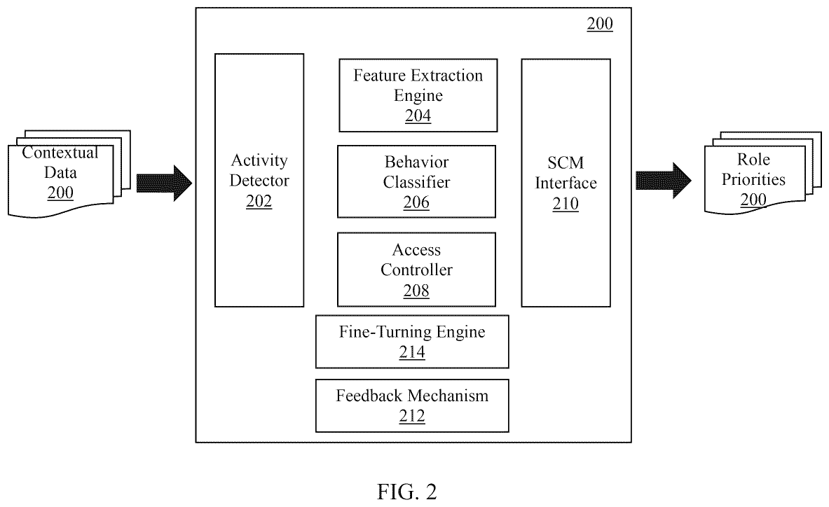

FIG. 2 illustrates an exemplary architecture of CBSP framework 200. In the exemplary architecture of FIG. 2, CBSP framework 200 illustratively includes activity detector 202, feature extraction engine 204, behavior classifier 206, access controller 208, and security and compliance monitor (SCM) interface 210. Activity detector 202, feature extraction engine 204, behavior classifier 206, access controller 208, and security and compliance monitor (SCM) interface 210 operatively cooperate to control user access to resources, including information handling systems 102a-102n, of enterprise environment 100. CBSP framework 200 may additionally include feedback mechanism 212 and fine-tuning engine 214. As described in greater detail below, feedback mechanism 212 operates to provide feedback to fine-turning engine 214, which is configured to dynamically fine tune the machine learning model implemented by behavior classifier 206 to improve the performance of CBSP 200 even when conditions affecting operations of enterprise environment change over time. Feedback mechanism 212 may provide feedback in real time, and fine-tuning engine 214 likewise may fine tune the operations of behavior classifier 206 and/or access controller 208 in real time.

In certain embodiments, the components of CBSP framework 200 may be implemented in processor-executable instructions (software) that may run on an information handling system such as information handling system 400 described with respect to FIG. 400. In other embodiments, the components of CBSP framework 200 may be implemented in application-specific circuitry (hardware), with the components operatively coupled with one another. In yet other embodiments, the components of CBSP framework 200 may be implemented in a combination of software and hardware.

Activity detector 202 may operatively couple with the enterprise IT infrastructure of enterprise environment 100. The enterprise IT infrastructure may include various discrete systems and devices, including information handling system 102a-102n, as well as databases and other resources. Activity detector 202 is configured to collect user contextual data in response to a user attempting to access a resource of the enterprise IT infrastructure. The contextualized data may be collected from multiple networked sources coupled with data communications network 104.

For example, contextualized data collection by activity detector 202 may be initiated by the user's logging onto a system or platform of enterprise environment 100, or, previously having logged on, attempting to access via data communications network 104 a database or other resource. Activity detector 202 may identify the user from a username and password entered by the user, from the capture of certain biometric data, and/or based on other authentication data electronically stored in an active directory or other database. The directory may map multiple users to assigned roles, and activity detector 202 may perform a lookup operation to identify the user's role and corresponding priority. The priority may dictate which resources of enterprise environment 100 the user is entitled to access. One distinguishing aspect of CBSP 200 that is distinct from static RBAC systems, for example, is acknowledgment that notwithstanding the stored role priority assigned to the user, there may be current contexts that warrant elevating or demoting the role priority assigned to the user. That is, the user's actions in logging into the enterprise IT infrastructure or attempting to access data or some other resources are evaluated by CBSP 200 in a current context determined from the contextual data.

The context may encompass multiple, interrelated real-time conditions of the enterprise IT infrastructure of enterprise environment 110 and/or multiple real-time aspects related to the user's action. In certain embodiments, these aspects include the user's current physical or network-based geographical location. In some embodiments, the context includes the current time in which the user attempts to access a resource of the enterprise IT infrastructure of enterprise environment 110. In some embodiments, the context includes the type of device being used, such as a desktop, mobile, or other device. Other contexts include, for example, real-time network conditions (e.g., bandwidth, activities, anomalies) of data communications network 104.

The contextualized data collected by activity detector 202 is fed into feature extraction engine 204 coupled with activity detector 202. Feature extraction engine 204 is configured to extract features from the contextualized data collected by activity detector 202. Additionally, the features extracted may be normalized by feature extraction engine 204. In various embodiments, feature extraction engine 204 may be configured to implement different feature extraction procedures. The feature extraction procedures implemented by feature extraction engine 204 may include, for example, principal component analysis (PCA) to reduce the dimensionality of the contextualized data by transforming the data into principal components that nonetheless retain the data's original variance. In certain embodiments, feature extraction engine 204 may be configured to implement one or more feature engineering processes to create new features that, based on expert-determined domain knowledge, capture underlying patterns within the contextualized data. In certain embodiments, feature extraction engine 204 also may be configured to normalize the data such that none of the contexts represented in the data dominate any others represented.

Feature extraction implemented by feature extraction engine 204 transforms the contextualized data collected by activity detector 202 into numerical representations formatted for input into and processing by a machine learning model. The features together may be represented by an n-tuple or feature vector, each element of which is a value that numerically represents a feature. Feature extraction engine 204 thus transforms the contextual data into a vector or higher-order tensor for processing by a machine learning model.

Behavior classifier 206 is configured to implement a machine learning model that is trained to generate a role prediction by classifying behavior of the user attempting to access a resource of enterprise environment 100, the classifying based on input of the features extracted by the feature extraction engine 204. The machine learning model classifies the behavior of the user, within a current context. For example, the behavior may be attempting to access a specific resource, at a particular time, using a specific type of device, while data communication network 104 is experiencing a certain level of network activity. In various embodiments, behavior classifier 206 may be configured to implement a machine learning model that is trained through supervised learning to recognize patterns of user behavior based on the features. Behavior classifier 206 thus may be configured to classify the behavior of a user attempting to access a resource of enterprise environment 100 based on recognition of statistical patterns (e.g., probability densities) of user behavior. In certain embodiments, behavior classifier 206 may be configured to implement a deep neural network whose parameters are iteratively adjusted until the model achieves an acceptable level of accuracy in classifying behaviors. Behavior classifier 206, in other embodiments may be configured to implement other types of machine learning models trained through supervised learning. Behavior classifier 206, for example, may be configured to implement a relatively uncomplex k-nearest neighbors (k-NN) model or an easily interpretable decision tree or random forest model. In still other embodiments described below, the machine learning model may be trained through self-learning rather than supervised learning. Whichever machine learning model it implements, behavior classifier 206 is capable of generating a role prediction by classifying behavior of the user in real time.

Access controller 208 is configured to assign a role priority to the user based on the prediction generated by the machine learning model of behavior classifier 206. The role priority determines which resources of the enterprise IT infrastructure that the user currently seeking access to a resource of enterprise environment 100 is entitled to access. Access controller 208, in certain embodiments, is configured to dynamically modify in real time a role-based access control (RBAC) priority that was previously assigned to the user. Access controller 208, in other embodiments, may be configured to elevate or demote the role priority of the user. In some embodiments, if the classification by behavior classifier 206 indicates anomalous behavior, access controller 208 may be configured to restrict the user's access to specific resources of enterprise environment 100. Access controller 208, in yet other embodiments, may be configured to initiate a stepped-up authentication procedure (e.g., multi-factor authentication) in response to behavior classifier 206 classifying the user behavior as anomalous. In the various embodiments, access controller 208 is capable of deciding whether and how to modify the user's role priority in real time based on the role prediction generated with the machine learning model implemented by behavior classifier 206.

In addition to the ability to dynamically assign role priorities in real time, another technical advantage of CBSP framework 200 is the capability of balancing the inevitable trade-off between maintaining the security of enterprise environment 100's resources and providing sufficient access to resources so as not to impede the productivity of the users of the resources with unnecessary restrictions. It may be, for example, that a user attempting to access a specific resource (e.g., proprietary database storing sensitive data) has previously been granted access to the resource by an administrator even though the user's enterprise-assigned role does not have the required priority. It may be that the user's prior access was illegitimate, but alternatively, it may be that the user is temporarily working on a special project that necessitates the user's access to the resource. Granting access may expose enterprise environment 100 to further security breaches but denying access risks impeding the user's work on the special project. A static RBAC system typically would deny the user access based on the enterprise-designated role previously assigned to the user. By contrast, in several embodiments of CBSP framework 200, the parameters of machine learning model used to predict user roles that determine role priorities may dynamically adjust to changing conditions in a manner to optimize the trade-off between maintaining security and the users'need for access to resources of enterprise environment 100. The parameters are adjusted in a way the reflects the relative weight or importance of various contexts such as the time that access is sought, the device used, the user's geographic location, recent access history, and/or other contexts, including for example network activity on data communications network 104.

The machine learning model's prediction accuracy increases by successive adjustments to the model's parameters in response to feedback provided by feedback mechanism 212. Feedback mechanism 212 is configured to monitor the enterprise IT infrastructure and determine the outcome produced by each assignment of a role priority to a user made by access controller 208. That is, the outcome determines whether the assignment prevented exposure of data communication network 104 to a security breach or whether the assignment prevented a user's legitimately accessing a resource, impeding the completion of a desired task. To determine the outcome, feedback mechanism 212 may be configured to collect feedback from various sources within data communication network 104. Feedback mechanism 212, in some embodiments, may be coupled with a security information and event management (SIEM) system via SCM interface 210. The SIEM system may generate signals indicating the outcome of each assignment of a role priority by access controller 208 of CBSP framework 200.

Fine-tuning engine 214 is configured to fine tune the machine learning model implemented by behavior classifier 206 by adjusting the model's parameters based on the outcomes provided by feedback mechanism 212. The fine tuning by fine-tuning engine 214 is likely to optimize the trade-off between preventing potential security breaches of the enterprise IT infrastructure and providing the user access to the resource when the access is legitimately needed by the user. Optimizing the likelihood of maximizing the trade-off through a correct assignment is achieved by enhancing the machine learning model's predictive accuracy through successive, iterative adjustments of the model's parameters.

With supervised learning, each of the features extracted by the feature extraction engine 204 may be an element of n-tuple or feature vector that is input to the machine learning model implemented by behavior classifier 206. Access controller 208 generates a decision based on the role prediction of the machine learning model. The subsequently determined outcome provides an indication of whether the prediction was a correct one given the outcome produced by the role priority assignment made based on the role prediction. The same input (i.e., feature vector) may be correctly labeled according to the outcome and re-used as an additional example for training the machine learning model implemented by behavior classifier 206. Through feeding forward the input, the model generates a classification that can be compared to the correct label (i.e., according to the outcome), and through backpropagation, the model parameters adjusted so that the accuracy of the model improves.

A technical advantage of the process is that fine-tuning engine 214 may be configured to update the parameters of the machine learning in real time. Each attempt to access a resource of the enterprise IT infrastructure of enterprise environment 100 leads to a context-based classification by the machine learning model implemented by behavior classifier 206. The classification, in turn, leads to the role prediction used to assign a role priority to the user by access controller 208. Whether the prediction was correct depends on the outcome that follows the assignment of a role priority based on the prediction. Thus, the same input to the machine learning model that led to the outcome may be correctly labeled according to the outcome (e.g., correct or incorrect) by fine-tuning engine 214, which uses the now-correctly labeled input to further train the machine learning model through feeding forward the input and updating the model parameters through backpropagation. Thus, a significant technological advantage of feedback mechanism 212 and fine-tuning engine 214 is that the machine learning model may be trained in real time. Another significant technical advantage is the machine learning model may be trained continuously, or approximately so, without taking CBSP framework 200 offline. That is, fine-tuning engine 214 may update parameters of the machine learning model through online learning.

In other embodiments of CBSP framework 200, uses a machine learning model that is trained through self-learning. In certain embodiments, the machine learning model is a model trained through reinforcement learning, and the processes performed by behavior classifier 206 and access controller 208 may be performed by a reinforcement learning (RL) agent. The RL agent may learn through the awarding of rewards and penalties generated by a reward-penalty function in response to decisions by the RL agent in assigning role priorities to users. Input data into the reinforcement learning model may include interdependent tuples forming an ordered sequence of data organized as state-action-reward.

The RL agent operates within the framework of a Markov decision process (MDP) in which the RL agent learns by interacting with its environment. In the present context, the environment is enterprise environment 100, which may include user activities, external security threats, system and network configurations, and other contexts such as described above. The current state is the context in which a user is attempting to access a resource of enterprise environment 100. Contextual data may include the user's geographic location (e.g., physical or network-based), access history, type of device (e.g., mobile or desktop) , real-time network activities (e.g., anomalies, bandwidth usage, active connections), and behavioral metrics indicating user-specific patterns.

Operating within the MDP framework, the RL agent learns by interacting with the environment, which provides information on the current state. The RL agent uses the information to take an action, which in the present context is the assigning a role priority to the user attempting to access a resource of the enterprise environment 100. If the action produces a correct result, the RL agent is rewarded. Otherwise, the RL agent is penalized. A correct result may be one in which the RL agent provided the user legitimate access to the resource of the enterprise IT infrastructure or prevented a potential security breach by denying the user access to the resource. An incorrect result may be one in which the RL agent denied the user legitimate access to the resource of the enterprise IT infrastructure or exposed the enterprise IT infrastructure to a security breach by providing the user access to the resource. The process of generating rewards or penalties repeats with each user access attempt. The RL agent learns through the awarding of rewards and penalties which action (role priority assignment) given the current state (user context) is most likely to be correct. A significant technical advantage is that the RL agent is capable of assigning role priorities in real time based on the current state of enterprise environment 100. Another significant advantage is that the RL agent learns in real time and without having to be trained offline. The RL agent's accuracy in correctly predicting an appropriate assignment of a role priority is likely to improve continuously, or nearly so, with each new action taken in assigning the role priority.

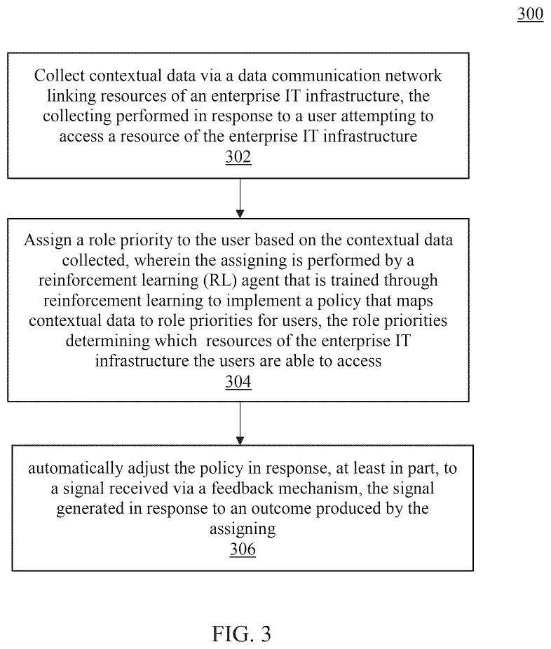

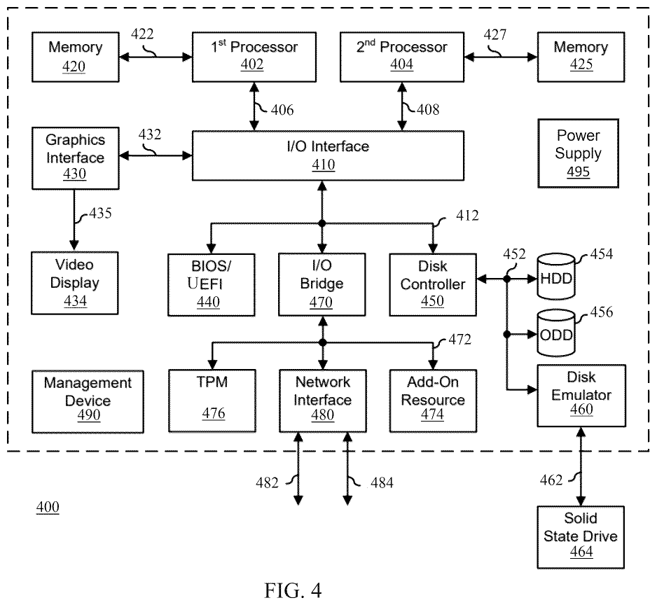

FIG. 3 is a flow diagram of a method 300 for controlling user access to resources of an enterprise IT infrastructure in real time, according to at least one embodiment of the present disclosure. It will be readily appreciated that not every method step set forth in this flow diagram is always necessary, and that certain steps of the methods may be combined, performed simultaneously, in a different order, or perhaps omitted, without varying from the scope of the disclosure. Method 300 may be performed by an information handling system such as information handling system 400, which is described below with reference to FIG. 4. The information handling system may include a processor, and a memory coupled to the processor, the memory storing program instructions that when executed by the processor cause the information handling system to perform the operations of method 300.

At block 302, the information handling system collects contextual data via a data communication network linking resources of the enterprise IT infrastructure. The collecting may be initiated in response to a user attempting to access a resource of the enterprise IT infrastructure. The contextual data, in certain embodiments, includes a user identifier (e.g., name and password), the current geographic location of the user, the device being used in attempting to access the resource, the user's access history (e.g., frequency, time, and resources accessed). In some embodiments, the contextual data may additionally, or alternatively, include real-time network activity (e.g., anomalies, bandwidth usage, active connections) and/or other behavioral metrics (e.g., user-specific patterns of resource usage). The contextual data provides the context for determining a correct response.

For example, the user may have logged into the network of the enterprise from a new geographic location using an unfamiliar device and be attempting to access a database storing sensitive data. The context is suspicious. Weighing against suspicion, however, may be an access history revealing that the user has a long history with the enterprise and has in the past received permission to access sensitive data. Given the contradictory indicia, it may be difficult to determine the likelihood of unnecessarily impeding the user's work by denying access versus that of exposing the enterprise IT infrastructure to a potential security breach by granting access. Assessing the relative probabilities may not be practically performed in the human mind, and likely not in real time. Unless someone currently has direct observation of the user, it would be humanly impossible to determine the geographic location of the user, or the type of device being used. Under no circumstances would it be possible for a human to make the decision based on real-time network activity such as bandwidth usage, anomalies, or the like. Even with respect to assessing the user's access history, it is likely impractical for a human to adequately access the history in real time given its extensive nature.

At block 304, the information handling system assigns a role priority to the user based on the contextual data collected at block 302. The information handling system is configured to implement an RL agent that is trained through reinforcement learning to perform the assigning of role priorities according to a policy mapping contextual data to role priorities for users. The role priorities assigned to users by the RL agent determine which resources of the enterprise IT infrastructure the users are able to access. The RL agent is capable of assigning a role priority to the user based on the collected contextual data in real time.

The role priority assigned thus determines in real time, without human intervention, whether the user presently attempting to access the resource may legitimately do so. In some embodiments, in assigning a role priority the RL agent may adjust an RBAC priority previously assigned to the user. In other embodiments, the RL agent may restrict user access to one or more specific resources of the enterprise IT infrastructure. In yet other embodiments, the RL agent may initiate a stepped-up authentication such as requiring a multi-factor authentication (MFA).

At block 306, the information handling system automatically adjusts the policy in response, at least in part, to a signal received via a feedback mechanism, wherein the signal is generated in response to an outcome produced by the assigning a role priority by the RL agent. Information handling system may adjust the policy in real time in response to each signal generated in response to an outcome produced by the RL agent's assigning a role priority

The automatic adjusting may be performed by accumulating rewards and penalties output by a reward-penalty function in response to signals generated in response to a plurality of outcomes produced. In certain embodiments, the reward-penalty function is configured to assign a reward in response to determining that the assignment of role priority provided the user legitimate access to the resource of the enterprise IT infrastructure or prevented a potential security breach by denying the user access to the resource. Conversely, in accordance with the same embodiments, the reward-penalty function is configured to assign a penalty in response to determining that the RL agent's decision denied the user legitimate access to the resource of the enterprise IT infrastructure or exposed the enterprise IT infrastructure to a security breach by providing the user access to the resource.

FIG. 4 shows a generalized embodiment of an information handling system 400 according to an embodiment of the present disclosure. Information handling system 400 may be the same or substantially similar to an information handling system capable of performing method 300 as described with reference to FIG. 3. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable mediums for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. A system to control, in real time, user access to resources of an enterprise information technology (IT) infrastructure, the system comprising:
an activity detector configured to collect contextual data from one or more data sources in response to a user attempting to access a resource of the enterprise IT infrastructure;
a feature extraction engine coupled with the activity detector, wherein the feature extraction engine is configured to extract features from the contextual data collected by the activity detector;
a behavior classifier coupled with the feature extraction engine, wherein the behavior classifier is configured to implement a machine learning model trained to generate a role prediction by classifying behavior of the user based on input of the features extracted by the feature extraction engine; and
an access controller coupled with the behavior classifier, wherein the access controller is configured to assign a role priority to the user based on the prediction generated by the machine learning model, wherein the role priority determines which resources of the enterprise IT infrastructure the user is able to access.

2. The system of claim 1, further comprising:
a feedback mechanism configured to monitor the enterprise IT infrastructure and determine an outcome of modifying a role-based access control (RBAC) priority,
wherein the outcome indicates whether modifying the RBAC priority correctly provided a user legitimate access to the resource of the enterprise IT infrastructure or prevented a potential security breach by denying the user access to the resource, or whether the modifying incorrectly exposed the enterprise IT infrastructure to a security breach or denied the user legitimate access to the resource.

3. The system of claim 2, further comprising:
a fine-tuning engine configured to fine tune the behavior classifier based on the outcome, wherein fine tuning by the fine-tuning engine maximizes a likelihood that a trade-off between preventing potential security breaches of the enterprise IT infrastructure and providing the user access to the resource when the access is legitimately needed by the user is optimized.

4. The system of claim 3, wherein the fine-tuning engine is configured to update parameters of the machine learning model in response to the outcome.

5. The system of claim 4, wherein the fine-tuning engine is configured to update the parameters of the machine learning model in real time.

6. The system of claim 5, wherein the fine-tuning engine is configured to update the parameters through online learning.

7. The system of claim 1, further comprising:
a compliance interface configured to communicatively couple with a device of an administrator the enterprise IT infrastructure.

8. A method for controlling, in real time, user access to resources of an enterprise information technology (IT) infrastructure, the method comprising:
collecting contextual data via a data communication network linking resources of the enterprise IT infrastructure, wherein the collecting is in response to a user attempting to access a resource of the enterprise IT infrastructure;
assigning a role priority to the user based on the contextual data collected, wherein the assigning is performed by a reinforcement learning (RL) agent that is trained through reinforcement learning to implement a policy that maps contextual data to role priorities for users, the role priorities determining which resources of the enterprise IT infrastructure the users are able to access; and
automatically adjusting the policy in response, at least in part, to a signal received via a feedback mechanism, wherein the signal is generated in response to an outcome produced by the assigning.

9. The method of claim 8, wherein the automatically adjusting includes accumulating rewards and penalties output by a reward-penalty function in response to signals generated in response to a plurality of outcomes produced.

10. The method of claim 9, wherein the automatically adjusting is performed in real time in response to each signal generated.

11. The method of claim 9, wherein reward-penalty function assigns a reward in response to determining that the assigning provided a user legitimate access to the resource of the enterprise IT infrastructure or prevented a potential security breach by denying the user access to the resource.

12. The method of claim 9, wherein reward-penalty function assigns a penalty in response to determining that the assigning denied a user legitimate access to the resource of the enterprise IT infrastructure or exposed the enterprise IT infrastructure to a security breach by providing the user access to the resource.

13. The method of claim 8, wherein the contextual data includes data indicating at least one of a user location, user access history, type of user device, real-time activities of the data communication network, and user-specific behavioral metrics.

14. The method of claim 8, wherein the assigning a role priority includes one of adjusting a role-based access control (RBAC) priority of the user, restricting access to one or more specific resources, or initiating a stepped-up authentication.

15. An information handling system, comprising:
a processor; and
a memory coupled to the processor, the memory having program instructions stored thereon that, upon execution by the processor, cause the information handling system to perform operations including:
collecting contextual data via a data communication network linking resources of an enterprise IT infrastructure, wherein the collecting is in response to a user attempting to access a resource of the enterprise IT infrastructure;
assigning a role priority to the user based on the contextual data collected, wherein the assigning is performed by a reinforcement learning (RL) agent that is trained through reinforcement learning to implement a policy that maps contextual data to role priorities for users; and
automatically adjusting the policy in response, at least in part, to a signal received via a feedback mechanism, wherein the signal is generated in response to an outcome produced by the assigning.

16. The information handling system of claim 15, wherein the automatically adjusting includes accumulating rewards and penalties output by a reward-penalty function in response to signals generated in response to a plurality of outcomes produced.

17. The information handling system of claim 16, wherein the automatically adjusting is performed in real time in response to each signal generated.

18. The information handling system of claim 16, wherein reward-penalty function assigns a reward in response to determining that the assigning provided a user legitimate access to the resource of the enterprise IT infrastructure or prevented a potential security breach by denying the user access to the resource.

19. The information handling system of claim 16, wherein reward-penalty function assigns a reward in response to determining that the assigning denied a user legitimate access to the resource of the enterprise IT infrastructure or exposed the enterprise IT infrastructure to a security breach by providing the user access to the resource.

20. The information handling system of claim 15, wherein the contextual data includes data indicating at least one of a user location, user access history, user device, real-time activities of the data communication network, and user-specific behavioral metrics.
